(19) United States
(12) Patent Application Publication
(10) Pub. No.: US 2009/0049548 A1
(43) Pub. Date: Feb. 19, 2009

(54) Semiconductor Device and Method For Preventing Attacks on the Semiconductor Device

(75) Inventors: Joachim Christoph Hans Garbe, Schenefeld (DE); Soenke Ostertun, Wedel (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/090,732

(22) PCT Filed: Oct. 16, 2006
(86) PCT No.: PCT/IB2006/053798

§ 371 Date: Apr. 18, 2008

(30) Foreign Application Priority Data
Oct. 24, 2005 (EP) 05109899.4

(51) Int. Cl. G06F 21/02; G06F 12/16; G06F 12/00

(52) U.S. Cl. 726/22; 711/161; 711/159; 711/E12.001; 711/E12.103

(57) ABSTRACT

The invention relates to a method and to a semiconductor device, comprising means for detecting an unauthorized access to the semiconductor device, wherein the semiconductor device carries out an initialization of the semiconductor device following detection of an unauthorized access, wherein an information item relating to the unauthorized access can be stored by the semiconductor device prior to the initialization, and wherein the stored information item relating to the unauthorized access remains intact following the initialization of the semiconductor device. It is advantageously provided that the stored information item remains intact for a predetermined period of time following disconnection of the semiconductor device from a power supply.

The invention relates to a semiconductor device which carries out an initialization following an attack on the semiconductor device, and to a corresponding method. Such semiconductor devices are used in particular as chips for smart cards. Typically stored on smart card chips are information items which are intended to be able to be called up only by authorized persons. These information items are, for example, secret information items which serve to identify the user or to authorize said user. Such information items ought not to be accessible from outside, since they can otherwise be put to misuse. It is absolutely necessary to protect key data in particular, which serve to encrypt information items carried on the outside.

Attacks on the security or integrity of such products consist inter alia in exposing the chip to operating conditions which lie outside its specification, that is to say for example with regard to temperature, light, supply voltage, clock rate, or in applying voltage spikes to the chip. As a result, the intention is to disrupt the functioning of the smart card chip in such a way that it passes into an uncontrolled operating state and carries out uncontrolled, unintended operations, from which information concerning the stored protected data can be derived.

For example, it is possible for attack purposes to erase the security bit of the PIC 16C84 microcontroller by setting the supply voltage to Vpp −0.5 V (programming voltage). This is because some random number generators which are also located on the smart card chip increasingly generate the value 1 when the supply voltage is reduced slightly.

To protect against such attacks, it is known to equip smart cards with sensors which detect disruptions in the operating conditions. Such sensors are, for example, voltage sensors, temperature sensors, frequency sensors and detectors for light and voltage spikes.

One measure for protecting against attacks consists in that the chip destroys itself if it detects a disruption in the operating conditions, and thus blocks any possible outputting of the stored data. Alternatively, a corresponding information item could be permanently written to a memory. The disadvantage with both measures is that the chip becomes permanently unusable following a detected disruption in the operating conditions, that is to say for example even if the disruption is only random in nature, that is to say is non-malicious, or if the attacker gives up after a failed attack.

An alternative protective measure which avoids this disadvantage consists in that the chip automatically initializes following the detection of a disruption, in order thus to return to a defined operating state. The disadvantage with this measure is that the chip is exposed to attacks again after it has run through the initialization sequence. Since the duration of such an initialization is typically of the order of magnitude of only 100 microseconds, the attacks can be carried out very often within a short time, that is to say with high frequency. The attacker can thus hope that the smart card chip will ultimately disclose the stored information if he just attacks the chip a sufficient number of times. This is known as a “brute force attack”.

The object of the present invention is to provide a semiconductor device and a method which at least partially avoids the aforementioned disadvantages.

This object is achieved by the semiconductor device as claimed in claim 1 and by the method as claimed in claim 18.

The term “attack” in this context covers any type of influencing of the semiconductor device which is able to impair the security of information stored therein. Such attacks include in particular the measures mentioned above, for example exposing the semiconductor device to operating conditions which lie outside its specification.

The invention accordingly provides a semiconductor device which carries out an initialization of the semiconductor device following an attack, wherein an information item relating to the attack can be stored by the semiconductor device prior to the first initialization, and wherein the stored information item relating to the attack remains intact following the initialization of the semiconductor device.

The information item which is still available after an initialization indicates that an attack took place on the semiconductor device prior to the initialization. This information item can be used, once initialization has taken place, to commence further measures for preventing a renewed attack on the semiconductor device.

As a result, a semiconductor device is advantageously provided which greatly reduces the repetition rate of attacks on the security of the semiconductor device and thus increases the security of stored data without destroying the semiconductor device.

Preferably, the stored information item remains intact only for a predetermined period of time. This means that the semiconductor device can automatically return to a normal operating state once the period of time has elapsed.

This period of time can furthermore be predefined.

In one preferred embodiment, following an initialization of the semiconductor device, the stored information item is used to trigger a further initialization of the semiconductor device. As a result, an endless loop of initializations can be carried out. During the initialization operations, attacks on the semiconductor device are not possible.

Preferably, the stored information item remains intact for a predetermined period of time following disconnection of the semiconductor device from a power supply. The information item relating to the fact that an attack has taken place on the semiconductor device then continues to be available even following disconnection of the semiconductor device from a power supply. If the semiconductor device is reconnected to the power supply within the predetermined period of time, this information item can be used to trigger a further initialization, which once again can lead to an endless loop of initializations, whereby further attacks on the semiconductor device can be prevented in a particularly effective manner.

In a further refinement, the semiconductor device comprises means for storing the information item, preferably a capacitive element.

In a further refinement, means for charging the capacitive element and means for reading the charge status of the capacitive element are provided.

The predetermined period of time is preferably defined by the discharge current of the capacitive element.

In one preferred embodiment, the discharge current is passed via a consumer, preferably a diode.

On account of the discharging of the capacitive element, e.g. via the leakage current of a diode, the semiconductor device is available again after a certain length of time, said length of time being dependent on the discharge time of the capacitive element. As a result, different requirements in terms of security can be implemented. For smart card chips with very high security requirements, for example, the discharge time can be set to be very high using diodes with very low leakage currents.

Preferably, the consumer is protected by metal. Increased, undesired leakage currents due to manipulated light irradiation on the diode are thus avoided.

The semiconductor device comprises means for refreshing the charge of the capacitive element following an initialization of the semiconductor device.

In a further embodiment, the charge present in the capacitive element following an initialization of the semiconductor device can be refreshed after a predetermined number of attacks or a predetermined type of attack on the semiconductor device. It is thus possible to effectively prevent the situation whereby individual influences, which are not of a malicious nature, trigger continuous initializations of the semiconductor device. The information item relating to the number or type of attacks can be stored in additional storage means.

Preferably, the semiconductor device comprises at least one sensor for detecting an attack on the semiconductor device.

In a further embodiment, the means for storing the information item comprise a plurality of capacitive elements. As a result, a plurality of information items relating to attacks can be stored, wherein the information items may originate from different sensors.

In one preferred embodiment, the semiconductor device is an integrated circuit.

The invention also encompasses a smart card comprising at least one semiconductor device according to the invention.

The invention furthermore provides a method for preventing an attack on a semiconductor device, comprising the following steps:
detecting an attack on the semiconductor device;
storing an information item relating to the attack on the semiconductor device; and
carrying out an initialization of the semiconductor device, wherein the stored information item remains intact.

After carrying out the initialization, a further initialization can be carried out.

Preferably, after carrying out an initialization of the semiconductor device, the stored information item is refreshed.

Furthermore, the stored information item preferably remains intact for a predetermined period of time following disconnection of the semiconductor device from a power supply.

The information item stored in the storage device is erased from the storage device within a predefined period of time. The semiconductor device is then available again.

The invention will be further described with reference to an example of embodiment shown in the drawings to which, however, the invention is not restricted.

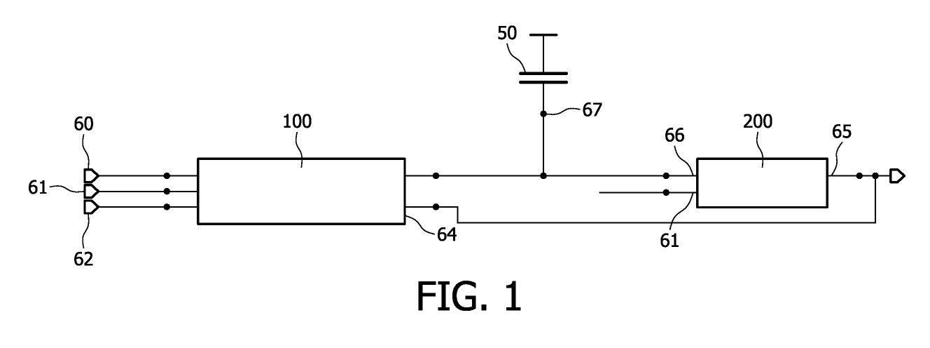

FIG. 1 shows a block circuit diagram of the semiconductor device according to the invention.

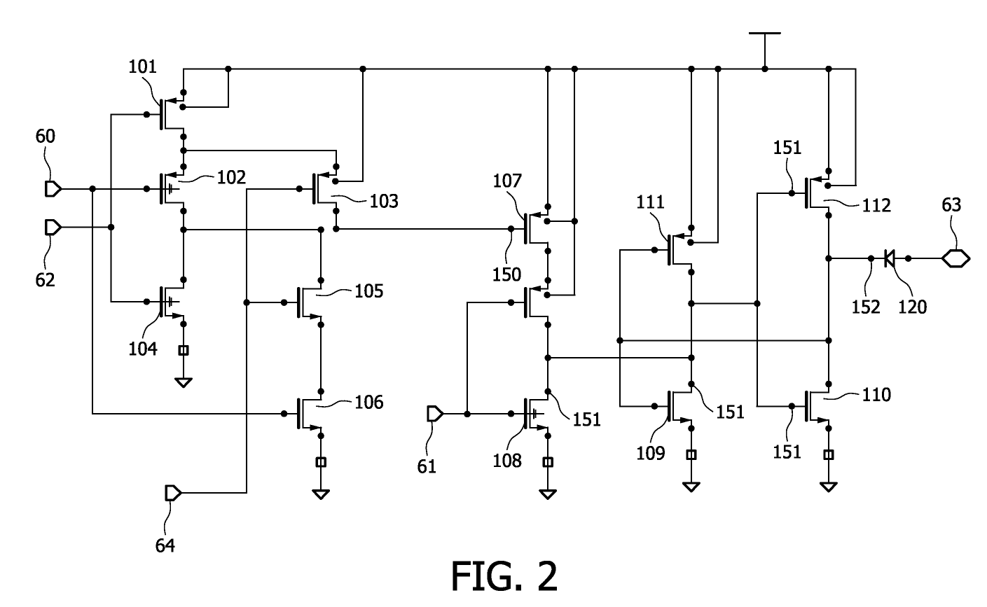

FIG. 2 shows a circuit diagram for writing information items.

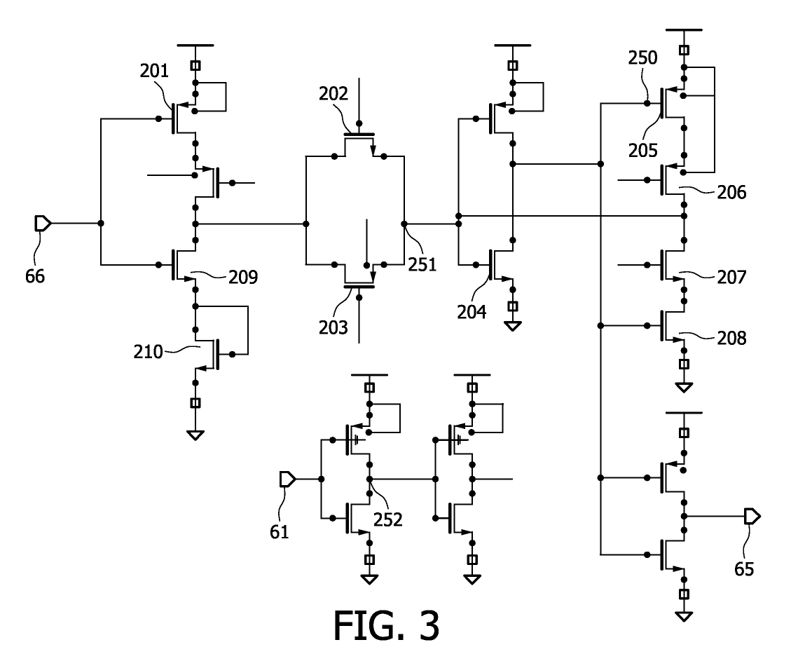

FIG. 3 shows a circuit diagram for reading information items.

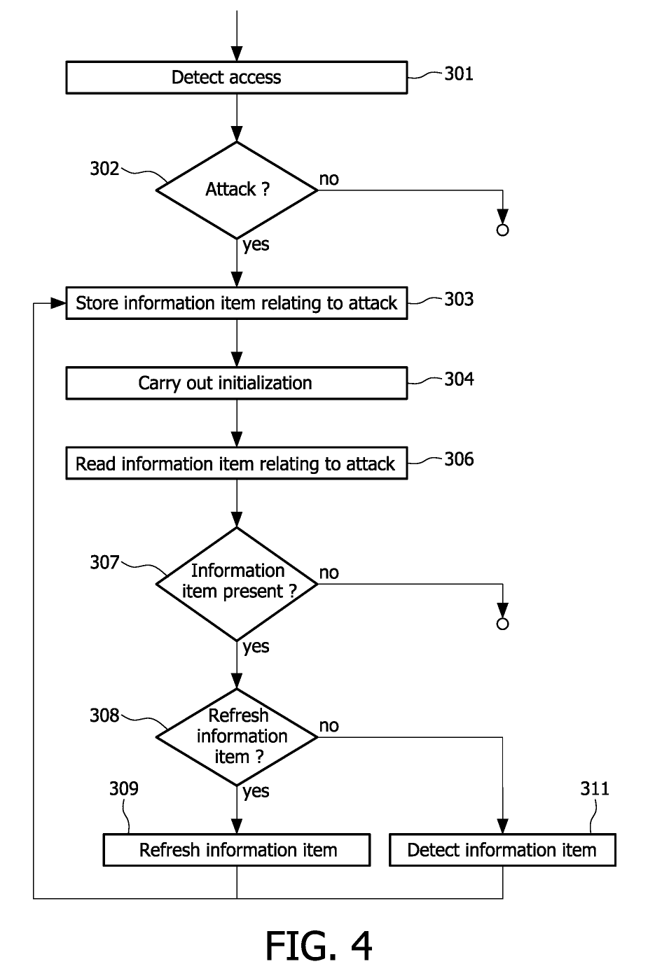

FIG. 4 shows a flowchart of the method according to the invention.

The text below describes an example of embodiment in which the semiconductor device is configured as a smart card chip. The smart card chip comprises means which store an information item relating to an attack. The information item may originate for example from the reaction of one of the aforementioned sensors. The reaction of such a sensor leads to an initialization of the smart card chip. According to the invention, this information item relating to an attack on the smart card chip continues to be available even after an initialization has taken place. Once initialization has taken place, these information items are read and used to trigger a further initialization. This gives rise to an endless loop of initializations, as a result of which any renewed attack on the smart card chip is blocked.

If the smart card chip is disconnected from the supply voltage, the stored information item relating to the attack continues to remain intact for a predetermined period of time before it is lost. This period of time preferably lies in the order of magnitude of one second. This ensures that a smart card chip can be made to function again relatively quickly following a non-malicious disruption which has nevertheless been detected as an attack. On the other hand, however, this time is around 10 000 times longer than that of a customary initialization, as a result of which the frequency of attacks is reduced by the same factor.

In the embodiment, the circuit comprises a capacitive element for storing the information item relating to the attack in the form of a charge. The circuit, which both stores the charge and reads the charge status, is designed in such a way that, if the supply voltage is switched off, the charge is lost only through the leakage current of a small diode. By using layout measures, such as for example the shielding of the diode with a metal layer, it is possible to prevent it from being possible for the leakage current to be manipulated from outside, for example by means of light irradiation.

Furthermore, the circuit can also be designed in such a way that not only does it automatically check the charge status of the capacitive element following an initialization, but it also automatically refreshes any existing charge in order to achieve again the predetermined storage time without a supply voltage.

One embodiment of the present invention is shown in FIGS. 1 to 3.

FIG. 1 shows a block circuit diagram of the semiconductor device according to the invention with the capacitor 50, which serves as a memory location for one bit, and a circuit block 100 for writing to the memory location and a circuit block 200 for reading from the memory location, that is to say for reading the charge status of the capacitor 50.

FIG. 2 shows a circuit diagram of the circuit block 100 for writing to the capacitor 50. When the supply voltage Vdd of the semiconductor device is switched on, one terminal of the storage capacitor 50 is also at Vdd. The other terminal is the node 67 on which charge can be stored. It is also brought capacitively to almost Vdd potential, since the storage capacitance is large compared to all the other capacitances on this node 67. This is the unwritten state.

When the memory bit is written, that is to say when the storage capacitor 50 is charged, this node 67 is placed at approximately 0 Volt. This is effected via the diode 120 in FIG. 2 when the node 152 is at 0 Volt. In this case, 0 Volt is not quite achieved.

The other transistors in FIG. 2 have purely a logic function and define the conditions under which a write operation takes place. In this embodiment, the transistors 111, 112, 109 and 110 form a latch which can be set and reset via the node 151. The write status is Vdd at 151. The transistor 108 ensures that the memory bit is reset after the semiconductor device is started, since here the signal 61 (power-on-reset) is at Vdd for a short time. A write operation can then be initiated via the transistor 107 when the gate potential 150 thereof is at 0 Volt.

The node 150 can be set to 0 Volt by Vdd at the signal 62 (programming input) via the transistor 104, or by Vdd at the signal 64 (Qin) via the transistor 105 if the transistor 106 is conducting simultaneously through Vdd and the signal 60 (auto-refresh).

The transistors 101 and 102 place the node 150 at Vdd, which means “non-writing”, when the signal 62 is at 0 Volt and at the same time the signal 60 is at 0 Volt. If the signal 60 is at Vdd, Vdd is applied to the node 150 via the transistor 103 when the signal 64 is at 0 Volt.

FIG. 3 shows a circuit diagram of the circuit block 200 for reading the charge status of the capacitor. The read result is at the output 65. When the output 65 is at Vdd, the bit was written. The node 250 is then at 0 Volt. The transistors 201, 205, 204 and 208 form a latch, which stores the read result. It can be set or reset only when the transmission gate from the transistors 202 and 203 is conducting, which is the case when the signal 61 is at Vdd and thus the inverted signal 252 is at 0 Volt, that is to say during an initialization process. In this case, the transistors 207 and 206 block the right-hand branch of the latch so that, when the latch is set, no cross-currents flow. If the signal 66 (In) is at Vdd, the node 251 is brought to approximately 0.5 Volt via the transistor 209 and the transmission gate, since a threshold voltage drops at the transistor 210. If the signal 66 is considerably below Vdd, the transistor 201 opens and attempts to raise the potential at the node 251. The lower the signal 66, the sooner a Vdd potential will result at the node 251 once the transmission gate has been switched off. The transistor 210 serves only to raise the switching threshold and is not absolutely necessary.

The mode of operation of the circuit shown in FIGS. 1 to 3 will be described below. The signal 62 allows programming of the memory bit. As a result, it is possible to fix an alarm signal in the event of detecting an unauthorized state of the semiconductor device. As long as the supply voltage Vdd is present, the memory bit—the charged capacitor 50—remains set. Resetting or discharging of the capacitor 50 is not provided in this embodiment and can take place only by way of an initialization (signal 61 at Vdd).

However, during an initialization, the memory content of the capacitor 50 is at the same time read and latched. As can be seen in FIG. 1, this read result 65 is at the same time the input 64 of the write circuit 100. When the input 60 is active, the read result 65 is thus used as input 64 for the write operation. As a result, the abovementioned endless loop of initializations is produced. The significant advantage lies in the fact that it is not possible for an attacker to carry out an attack on the smart card chip between two initializations, since the smart card chip is initialized at the same time as the capacitor 50 is read.

This arrangement is advantageous when the power supply Vdd is momentarily switched off. In this case, the capacitor 50 retains its charge and both sides are merely pulled by Vdd toward zero. A loss of charge of the capacitor 50 can take place only via the leakage currents in the diode 120. These leakage currents are very low, particularly when the diode 120 is protected against light irradiation and is of small dimensions. When the power supply Vdd is switched on again, even a small residual charge on the capacitor 50 may be sufficient, with an active auto-refresh signal 60, to bring the charge of the capacitor 50 back to the full value. In practice, storage times of seconds to minutes have been measured, depending on the size of the capacitor and the temperature.

Depending on requirements, in a further embodiment it is possible for the auto-refresh signal 60 to be activated only after multiple unauthorized accesses or a certain combination of unauthorized accesses. As a result, problems caused by individual random disruptions can be prevented. If the signal 60 were at 0 Volt, only an explicit setting of the memory bit through signal 62 to Vdd would be possible; otherwise one initialization is sufficient to erase the bit.

Of course, embodiments are also possible which allow the memory bit to be erased via a transistor. However, this transistor would shorten the storage times of the capacitor as a result of increased leakage currents.

FIG. 4 shows a flowchart of the method according to the invention. Following detection of an access in step 301, in step 302 a check is made to ascertain whether this is an attack. This check can be carried out for example by checking whether a number of attacks have taken place within a predetermined period of time. Using this procedure, it is possible to achieve a situation whereby individual random disruptions are not detected as unauthorized accesses. Of course, it is also possible for any access to be deemed to be an unauthorized access. If no unauthorized access exists, the method ends.

In the case of an attack, an information item relating to the attack is stored in the following step 303. Then, in step 304, an initialization of the semiconductor device is carried out. During this initialization, the semiconductor device is reset to its original state. The information item relating to the attack which was stored in step 303 is excluded from this resetting operation, and this information item is thus available even after the initialization.

The method continues with step 306, in which the information item relating to the attack which was stored in step 303 is read. If such an information item is present, which is checked in step 307, the method checks whether this information item should be refreshed, which takes place in the following step 309.

In the next step, the method returns to step 304 and carries out a further initialization of the semiconductor device. As a result, an endless loop of initializations is produced, which makes it very difficult for an attacker to obtain information from the smart card chip, since the initialization phase is greatly extended by the successive initializations and attacks are possible only between two initialization phases.

The circuit design as shown in FIG. 1 to FIG. 3 ensures that the stored information item remains intact for a certain period of time following removal of the supply voltage, since the capacitor 50 is discharged only slowly via the leakage currents of the diode 120. If the supply voltage is applied again to the semiconductor device within a certain period of time, a residual charge of the capacitor 50 may be sufficient to refresh said charge in step 309 and achieve again the full charge time. An attack on the smart card chip is thus not possible even after briefly removing the smart card chip from the supply voltage.

In a further embodiment, the method can be continued from step 308 with step 311 by discharging the capacitor, specifically when no refreshing of the stored information item is to take place. The method continues with the initialization step 304. With this embodiment, therefore, following an attack on the semiconductor device, the latter is available again after the capacitor 50 has been discharged, without having to disconnect the supply voltage from the semiconductor device.

One significant advantage of the invention is that attacks on the security of a smart card are made much more difficult without there being a risk of permanent functional disruption. Furthermore, it is possible to conceal such a circuit in the usual chip logic of a smart card chip. Security circuits which are located in the general logic part of a smart card chip are much more difficult to discover and manipulate than analog circuits which are located separately in an analog block. Another significant advantage is that the space requirement and thus the costs for such a circuit are very low.

### LIST OF REFERENCES

50 capacitor
60 auto-refresh signal
61 power-on-reset signal
62 programming signal or programming input
64 input signal or input of the write circuit
65 output signal or output of the read circuit
66 input signal or input of the read circuit
67 connection node of the capacitor
100 circuit block for writing to a capacitor (write circuit)
101-112 transistors in the write circuit
150 gate potential of the transistor 107
151 node at a potential with respect to the transistors 108, 109, 110 and 112
152 node at a potential with respect to the diode 120
200 circuit block for reading the charge status of a capacitor (read circuit)
201-210 transistors in the read circuit
250 node at a potential with respect to the transistor 205
251 node at a potential
252 inverted signal of the power-on-reset signal
301-311 method steps of the method according to the invention

1. A semiconductor device which carries out an initialization of the semiconductor device following an attack on the semiconductor device, characterized in that
an information item relating to the attack can be stored by the semiconductor device prior to the initialization; and
the stored information item relating to the attack remains intact following the initialization of the semiconductor device.

2. A semiconductor device as claimed in claim 1, characterized in that the stored information item remains intact only for a predetermined period of time.

3. A semiconductor device as claimed in claim 2, characterized in that the predetermined period of time can be defined.

4. A semiconductor device as claimed in claim 2, characterized in that, following an initialization of the semiconductor device, the stored information item can be used to trigger a further initialization of the semiconductor device.

5. A semiconductor device as claimed in claim 1, characterized in that the stored information item remains intact for a predetermined period of time following disconnection of the semiconductor device from a power supply.

6. A semiconductor device as claimed in claim 1, characterized in that it comprises means for storing the information item.

7. A semiconductor device as claimed in claim 6, characterized in that the storage means comprise a capacitive element, and means for charging the capacitive element and means for reading the charge status of the capacitive element are provided.

8. A semiconductor device as claimed in claim 7, characterized in that the predetermined period of time is defined by the discharge current of the capacitive element.

9. A semiconductor device as claimed in claim 8, characterized in that the discharge current is passed via a consumer, preferably a diode.

10. A semiconductor device as claimed in claim 9, characterized in that the consumer is shielded by metal.

11. A semiconductor device as claimed in claim 7, characterized in that it comprises means for refreshing the charge of the capacitive element following an initialization of the semiconductor device.

12. A semiconductor device as claimed in claim 7, characterized in that the charge present in the capacitive element following an initialization of the semiconductor device can be refreshed after a predetermined number of attacks or a predetermined type of attack on the semiconductor device.

13. A semiconductor device as claimed in claim 7, characterized in that it comprises means for detecting an attack on the semiconductor device.

14. A semiconductor device as claimed in claim 6, characterized in that the means for storing the information item comprise a plurality of capacitive elements.

15. A semiconductor device as claimed in claim 14, characterized in that a plurality of information items relating to attacks on the semiconductor device can be stored in the plurality of capacitive elements.

16. A semiconductor device as claimed in claim 14, characterized in that the semiconductor device is an integrated circuit.

17. A smart card comprising at least one semiconductor device as claimed in claim 14.

18. A method for protecting against attacks on a semiconductor device, comprising the following steps:
detecting an attack on the semiconductor device;
storing an information item relating to the attack on the semiconductor device; and
carrying out an initialization of the semiconductor device, wherein the stored information item relating to the attack remains intact.

19. A method as claimed in claim 18, characterized in that, after carrying out an initialization of the semiconductor device, a further initialization of the semiconductor device is carried out as a function of the stored information item.

20. A method as claimed in claim 18, characterized in that, after carrying out an initialization of the semiconductor device, the stored information item is refreshed.

21. A method as claimed in claim 17, characterized in that the stored information item is erased after a predetermined period of time.

22. A method as claimed in claim 17, characterized in that the stored information item remains intact for a predetermined period of time following disconnection of the semiconductor device from a power supply.
